(19) United States
(12) Patent Application Publication
(10) Pub. No.: US 2019/0330798 A1
(43) Pub. Date: Oct. 31, 2019

(54) REFINER BAR PLATE INCLUDING MICRO-FINE BAR AND METHOD FOR MANUFACTURING SAME

(71) Applicant: Byung Kul MIN, Busan (KR)

(72) Inventors: Byung Kul MIN, Busan (KR); Cheol Hwan KIM, Sacheon (KR); Hyeon Soo LIM, Gimhae (KR); Jae Hyeon Ahn, Jeonju (KR); Jung Jin LEE, Busan (KR); Dong Cheol KIM, Busan (KR)

(73) Assignee: Byung Kul MIN, Busan-si (KR)

(21) Appl. No.: 16/467,017

(22) PCT Filed: Nov. 24, 2017
(86) PCT No.: PCT/KR2017/013503

§ 371 Date: Jun. 5, 2019

(30) Foreign Application Priority Data
Dec. 14, 2016 (KR) 10-2016-0170321

(51) Int. Cl. D21D 1/26; B22D 19/00; B22D 17/00; B22C 9/22; B02C 7/12

(52) U.S. Cl. CPC D21D 1/26; B22D 19/00; B02C 7/12; B22C 9/22; B22D 17/00

(57) ABSTRACT

The present invention relates to a refiner bar plate including micro-fine bars and a method for manufacturing the same which further improve productivity during a refining process by manufacturing micro-fine bars to be finer and have a long lifespan. A first exemplary embodiment of the refiner bar plate according to the present invention provides the refiner bar plate including: a base which defines a body; and multiple fine bars which are spaced apart from one another, protrude from the base, and are made of a material different from a material of the base.

### TECHNICAL FIELD

The present invention relates to a refiner bar plate including micro-fine bars and a method of manufacturing the same, and more particularly, to a refiner bar plate including micro-fine bars and a method of manufacturing the same in which productivity is further improved during a refining process and a weight is reduced by adopting micro-fine bars which are finer and have a long lifespan.

### BACKGROUND ART

Raw materials such as wood or plant fibers or waste paper, which is discarded after use, are used to produce pulp. The raw materials are subjected to a refining treatment so as to have a form (internal fibrillation, external fibrillation, fiber disconnection, etc.) most suitable to manufacture paper through a refining treatment which is the most important process among paper making processes. In this case, a large amount of industrial water is used.

Therefore, components of a refiner, which is used to perform the refining process, need to have excellent wear resistance and have a bar having a perfect shape, and the components also need to have excellent corrosion resistance in order to withstand corrosion.

A bar plate, which is a component of the refiner for refining pulp and used for a conical bar type refiner or a DDR bar type refiner having a circular plate shape, is a consumable component, and the supply of the bar plates entirely depends on imports except for some bar plates.

Such a bar plate has a conical and circular disc shape formed in the form of a washboard as multiple plates having multiple bars are combined. The thin bars of about 0.6 to 6 mm are attached in a comb pattern in accordance with a type of pulp used for a surface of the disc. Two sets of a rotor, which is a rotating body, and a stator, which is stationary, are provided as one set, or a set of two stators and two rotors is provided and used to beat the raw materials for making paper.

The refiner is a device which mechanically fibrillates and refines pulp fibers from reticular tissue of the fibers that form woody fibrous materials such as wood chips, sawdust, and vegetable fibrous materials, thereby changing the pulp fibers so that the fibrous materials become appropriate to manufacture paper.

The refiner includes the rotor and the stator, and the above-mentioned fibrous materials are inputted between the rotor and the stator while the rotor rotates, such that the fibrous materials are fibrillated by the bars that protrude from a surface of the rotor and a surface of the stator which face each other. For this reason, the bar plate is made of a material required to have wear resistance, high tension, corrosion resistance, and the like.

Meanwhile, examples of the refiner include a conical type refiner as illustrated in FIG. 1, and a disc type refiner (not illustrated) having a circular plate shape. Both of the refiners each have a rotor 20 and a stator 10, and multiple refiner bar plates 30 may be coupled to each of the rotor 20 and the stator 10.

As illustrated in FIG. 2, the refiner bar plate 30 may include a base 32 and bars 34.

The base 32 is a constituent element for defining a bottom plate, and the multiple bars 34 may be spaced apart from one another and may protrude from the base 32.

The refiner bar plates 30 are provided on a surface of the rotor 20 and a surface of the stator 10 which face each other. The refiner bar plates 30 rotate relative to one another as the rotor 20 rotates, and the fibrous materials flow through grooves 36 between the bars 34, such that the bars 34 of the rotating rotor 20 mechanically refine the pulp (fibrous materials) that pass through the grooves 36.

Meanwhile, the refiner bar plate 30 may be formed generally by a casting process method.

According to a process method of manufacturing the refiner bar plate 30 in the related art by using casting, a model, which has a shape of the refiner bar plate 30 to be cast, is manufactured first, the model is positioned in a flask, and resin coated sand RCS is inputted and heated to fire a sand mold.

Further, ingot steel is injected into the manufactured sand mold and then cooled, such that the refiner bar plate 30 is cast.

In general, in the case of the most castings, a core is manufactured by using a wooden or metal mold, and in this case, the mold needs to necessarily have a draft in order to draw out the core. Therefore, when firing the sand mold by using the resin coated sand, the draft may be formed on the mold to prevent the sand mold from being collapsed or damaged.

The sand mold manufactured by the mold also has a draft, and as illustrated in FIG. 3, a draft is also applied to the refiner bar plate 30 manufactured by the sand mold.

The draft is applied by forming the bar 34 of the refiner bar plate 30 so that a lateral surface of the bar 34 is inclined with respect to the base 32. In general, the draft has an angle of about 1 to 2.5 degrees.

Meanwhile, the bar is worn as the refiner bar plate 30 is used, and the refiner bar plate 30 is replaced when the bar is worn and reaches or exceeds a wear limit.

By the way, to implement the uniform fibrillation, an interval between an end of the bar 34 of the refiner bar plate 30 provided on the stator 10 and an end of the bar 34 of the refiner bar plate 30 provided on the rotor 20 needs to be constantly maintained even though the refiner bar plate 30 becomes worn.

Therefore, how much the refiner bar plate 30 is worn is checked at a process site at every predetermined time, and the interval between the stator 10 and the rotor 20 is maintained by being decreased to the extent that the refiner bar plate 30 is worn, as illustrated in FIG. 4.

However, as illustrated in FIG. 5, a thickness of the bar is increased toward the base 32 since the draft is applied to the bar 34 of the refiner bar plate, and thus a volume of the groove 36 through which the inputted fibrous materials flow is decreased, and as a result, there is a problem in that a flow rate is decreased, and productivity is also decreased.

For example, when the draft having an angle of 1 degree is applied and a thickness of an upper portion of the bar is 2 mm, a thickness of a lower portion of the bar is 3 mm, such that a volume of the groove between the bars is decreased downward.

In addition, the thickness of the bar 34 is decreased toward the end of the bar 34 since the draft is applied, and as a result, there is a problem in that a portion where the bar 34 is disposed becomes long and thin, which may cause damage to the core.

Meanwhile, the bar 34 is a portion of the refiner bar plate which is mainly worn. Since the bar 34 is formed by the casting method, the bar 34 is inevitably made of a material identical to a material of the base, and the bar 34 is inevitably made of a material that may be subjected to the casting method. There is a limitation in selecting materials. That is, the bar 34 needs to be made of materials strong against wear. However, it is difficult to make a casting by using these materials in most, and a large amount of costs is incurred in a case in which the cast bar 34 or the refiner bar plate 30 is subjected to the post-processing such as a heat treatment or forging.

### DISCLOSURE

### Technical Problem

The present invention has been made in an effort to solve the above-mentioned problems, and an object of the present invention is to provide a refiner bar plate including micro-fine bars which are strong against wear and prevent a decrease in flow rate even though the micro-fine bars are worn, and a method of manufacturing the same.

Another object of the present invention is to provide a method of casting a refiner bar plate, a refiner bar plate cast by using the method, and a refiner including the refiner bar plate, which allow the refiner bar plate to be uniformly worn such that the refiner bar plate may be used until life expectancy.

Technical problems of the present invention are not limited to the aforementioned technical problems, and other technical problems, which are not mentioned above, may be clearly understood by those skilled in the art from the following descriptions.

### Technical Solution

To achieve the above-mentioned objects, a first exemplary embodiment of the present invention provides a refiner bar plate including: a base which defines a body; and multiple fine bars which are spaced apart from one another, protrude from the base, and are made of a material different from a material of the base.

The fine bar may include an embedded portion which is embedded in the base, and a protruding portion which protrudes from the base.

At least one hole or protrusion may be formed on the embedded portion of the fine bar.

The fine bar may have a constant thickness from the embedded portion to the protruding portion, or the fine bar may gradually decrease in thickness from the embedded portion toward the protruding portion.

One side of a cross section of the fine bar may be perpendicular to the base, and the other side of the cross section of the fine bar may be inclined such that a thickness of the fine bar is decreased toward an end of the protruding portion.

A dam may be further formed to protrude from the base between the fine bars.

Meanwhile, a first exemplary embodiment of a method of manufacturing the refiner bar plate according to the first exemplary embodiment of the present invention provides a method of manufacturing a refiner bar plate, the method including: an insertion step of inserting fine bars, in an inverse manner, into a first bar assembling jig having multiple insertion grooves which are spaced apart from one another at predetermined intervals and into which the fine bars are inserted in an inverse manner; a mold joining step of positioning and joining a first lower mold, which is joined to an upper portion of the first bar assembling jig to define a space between the first lower mold and the first bar assembling jig in which a base is formed, to the upper portion of the first bar assembling jig into which the fine bars are inserted; a preheating step of preheating the first bar assembling jig and the first lower mold which are joined together; and a casting step of forming the base by injecting ingot steel, which is made of a material different from a material of the fine bar, into the internal space between the preheated first bar assembling jig and the preheated first lower mold.

Meanwhile, a second exemplary embodiment of the method of manufacturing the refiner bar plate according to the first exemplary embodiment of the present invention provides a method of manufacturing a refiner bar plate, the method including: an insertion step of inserting fine bars, in a normal manner, into a second bar assembling jig having multiple insertion grooves which are spaced apart from one another at predetermined intervals and into which the fine bars are inserted in a normal manner; a first upper shell mold forming step of manufacturing a first upper shell mold, into which the fine bars are inserted in an inverse manner, by placing a flask on an upper portion of the second bar assembling jig into which the fine bars are inserted, filling the flask with resin coated sand, and heating the resin coated sand; a mold joining step of positioning and joining a second lower mold, which is joined to an upper portion of the second bar assembling jig to allow a base to be formed between the second lower mold and the second bar assembling jig, to an upper portion of the first upper shell mold; and a casting step of forming the base by injecting ingot steel, which is made of a material different from a material of the fine bar, into an internal space between the first upper shell mold and the second lower mold.

Meanwhile, a third exemplary embodiment of the method of manufacturing the refiner bar plate according to the first exemplary embodiment of the present invention provides a method of manufacturing a refiner bar plate, the method including: an insertion step of inserting fine bars, in a normal manner, into a second bar assembling jig having multiple insertion grooves which are spaced apart from one another at predetermined intervals and into which the fine bars are inserted in a normal manner; a first upper shell mold forming step of manufacturing a first upper shell mold, into which the fine bars are inserted in an inverse manner, by placing a flask on an upper portion of the second bar assembling jig into which the fine bars are inserted, filling the flask with resin coated sand, and heating the resin coated sand; a first lower shell mold forming step of forming a lower mold by positioning a flask and a lower core on an upper portion of the first upper shell mold, filling the flask with resin coated sand, and heating the resin coated sand; a mold joining step of joining the first upper shell mold and the first lower shell mold; and a casting step of forming a base by injecting ingot steel, which is made of a material different from a material of the fine bar, into an internal space between the first upper shell mold and the first lower shell mold.

Meanwhile, a fourth exemplary embodiment of the method of manufacturing the refiner bar plate according to the first exemplary embodiment of the present invention provides a method of manufacturing a refiner bar plate, the method including: a second upper shell mold forming step of manufacturing a second upper shell mold having insertion grooves into which fine bars are inserted by placing a flask on an upper mold having a shape of a silhouette in a state in which the fine bars are inserted in a normal manner, filling the flask with resin coated sand, and heating the resin coated sand; a fine bar insertion step of inserting the fine bars in an inverse manner into the insertion grooves of the manufactured second upper shell mold; a mold joining step of joining a first lower mold, which is joined to the second upper shell mold to define a space in which a base is formed, to an upper portion of the second upper shell mold into which the fine bars are inserted; and a casting step of forming the base by injecting ingot steel, which is made of a material different from the fine bar, into an internal space between the second upper shell mold and the first lower mold.

Meanwhile, a second exemplary embodiment of the refiner bar plate according to the present invention provides a refiner bar plate including: a fine bar plate having one surface which defines a bottom surface of a base of the refiner bar plate and to which multiple fine bars are coupled by welding; and the base which is formed by casting at a lower side of the fine bar plate, made of a material different from a material of the fine bar, and integrated with the fine bar plate.

The fine bar plate may further include: a skirt which is formed by bending both rims downward; a flange which is formed by bending an end of the skirt inward; and multiple ribs which protrude from a surface opposite to a surface of the fine bar plate to which the fine bars are coupled by welding, and the fine bar plate may be formed to be integrated with the base formed by casting.

Meanwhile, a fifth exemplary embodiment of the method of manufacturing the refiner bar plate according to the second exemplary embodiment of the present invention provides a method of manufacturing a refiner bar plate, the method including: a fine bar plate manufacturing step of coupling, by welding, multiple fine bars to one surface which defines a bottom surface of a base of the refiner bar plate; a mold joining step of placing the fine bar plate on an upper mold in an inverse manner and then joining a first lower mold to the upper mold; and a casting step of forming the refiner bar plate by injecting ingot steel, which is made of a material different from a material of the fine bar, into an internal space between the upper mold and the first lower mold.

Meanwhile, a third exemplary embodiment of the refiner bar plate according to the present invention provides a refiner bar plate including: a base which has multiple insertion grooves formed in one surface thereof; fine bars which are inserted into the insertion grooves of the base so as to protrude from the base and made of a material different from a material of the base; and fillers which are inserted into the insertion grooves together with the fine bars and then allow the fine bar to be welded on the base by brazing welding.

Meanwhile, a sixth exemplary embodiment of the method of manufacturing the refiner bar plate according to the third exemplary embodiment of the present invention provides a method of manufacturing a refiner bar plate, the method including: a filler insertion step of inserting a filler into an insertion groove of a base; a fine bar insertion step of inserting a fine bar, which is made of a material different from a material of the base, into the insertion groove into which the filler is inserted; and a heating step of performing brazing welding by melting the filler by heating the base into which the fine bar and the filler are inserted.

### Advantageous Effects

The refiner bar plate including micro-fine bars and the method of manufacturing the same according to the present invention have the following effects.

First, because the bar of the refiner bar plate is not formed by casting, a material, which is different from a material of the base and is strong against wear, may be used. The bar manufactured by a heat treatment or forging may be applied, such that the refiner bar plate strong against wear may be manufactured. As a result, a period of replacement of the refiner bar plate may be prolonged and thus productivity is improved.

Second, the bar, which is made of a material having high rigidity and elasticity, may be used, such that a thickness of the bar may be further decreased, and volumes of grooves through which inputted fibrous materials flow may be maximally increased, and as a result, productivity is improved.

Third, since a draft is not applied to the bar of the refiner bar plate and thus the bar and the base are perpendicular to each other, a width of the groove may not be reduced even though the refiner bar plate is worn, and a decrease in flow rate may be minimized, such that a decrease in productivity may be minimized, a period of replacement of the refiner bar may be prolonged, and thus productivity may be improved.

Fourth, in comparison with a refiner bar plate in the related art, weights of components may be reduced, the time taken to replace the components may be shortened, a capacity of a motor may be reduced, electric power consumed in operation may be reduced, and thus production costs and management costs may be reduced.

The effects of the present invention are not limited to the aforementioned effects, and other effects, which are not mentioned above, will be clearly understood by those skilled in the art from the claims.

### DESCRIPTION OF DRAWINGS

A detailed description of the exemplary embodiments of the present application to be described below as well as the summary explained above will be understood well when reading the detailed description and the summary with reference to the accompanying drawings. The exemplary embodiments are illustrated in the drawings for the purpose of exemplifying the present invention. However, it should be understood that the present application is not limited to the illustrated exact arrangement and means.

FIG. 1 is a view illustrating a general conical type refiner in the related art.

FIG. 2 is a cross-sectional view illustrating refiner bar plates provided on a stator and a rotor.

FIG. 3 is a cross-sectional view illustrating an angle of a draft of a bar of the refiner bar plate.

FIG. 4 is a cross-sectional view illustrating a change in interval in accordance with wear of the refiner bar plate.

FIG. 5 is a cross-sectional view illustrating a change in groove area of the refiner bar plate in accordance with wear.

FIG. 6 is a view illustrating a first exemplary embodiment of the refiner bar plate including micro-fine bars according to the present invention.

FIGS. 7A-7D show several examples of the fine bar in FIG. 6.

FIG. 8 a cross-sectional view taken along line A-A in FIG. 6 and illustrates dams between the bars.

FIGS. 9A-9D show a first exemplary embodiment of a method of manufacturing the refiner bar plate according to the present invention.

FIG. 10 is a cross-sectional view illustrating a first bar assembling jig in FIG. 9.

FIGS. 11A-11C show a second exemplary embodiment of the method of manufacturing the refiner bar plate according to the present invention.

FIGS. 12A-12E show a third exemplary embodiment of the method of manufacturing the refiner bar plate according to the present invention.

FIGS. 13A-13H show a fourth exemplary embodiment of the method of manufacturing the refiner bar plate according to the present invention.

FIG. 14 is a view illustrating a second exemplary embodiment of the refiner bar plate including the micro-fine bars according to the present invention.

FIGS. 15A-15D show a fifth exemplary embodiment of the method of manufacturing the refiner bar plate according to the present invention.

FIG. 16 is a view illustrating a third exemplary embodiment of the refiner bar plate including the micro-fine bars according to the present invention.

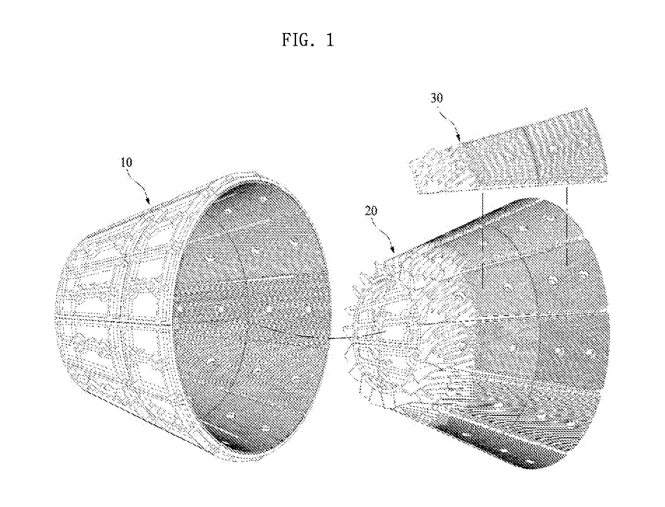

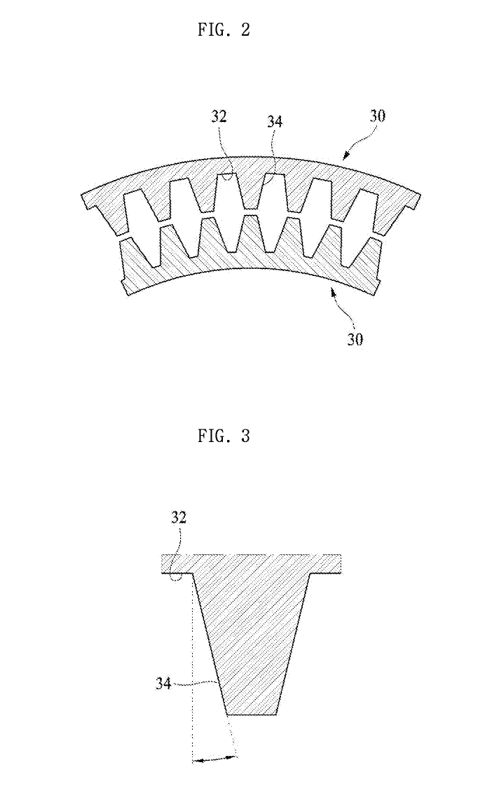

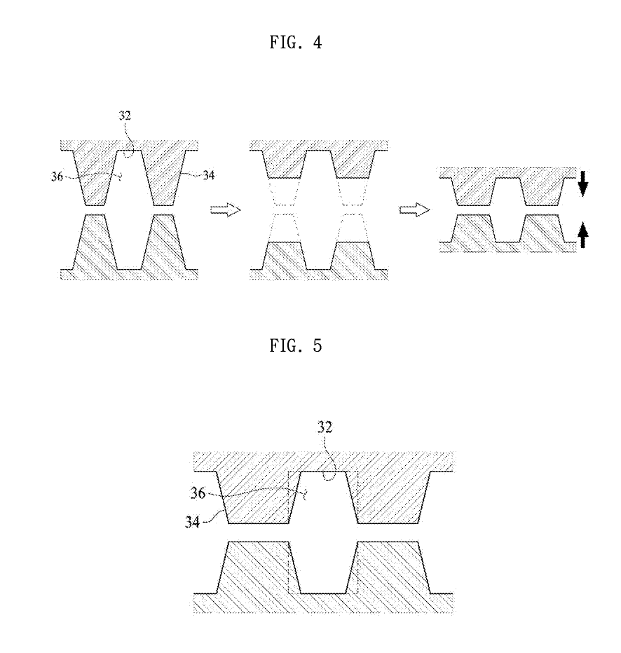

### BEST MODE

Hereinafter, exemplary embodiments of the present invention for specifically accomplishing the objects of the present invention will be described with reference to the accompanying drawings. In the description of the present exemplary embodiments, like terms and like reference numerals are used for like configurations, and additional descriptions for the like configurations will be omitted.

Hereinafter, a first exemplary embodiment of a refiner bar plate including micro-fine bars (hereinafter, referred to as a ‘refiner bar plate’ for convenience of description) according to the present invention will be described.

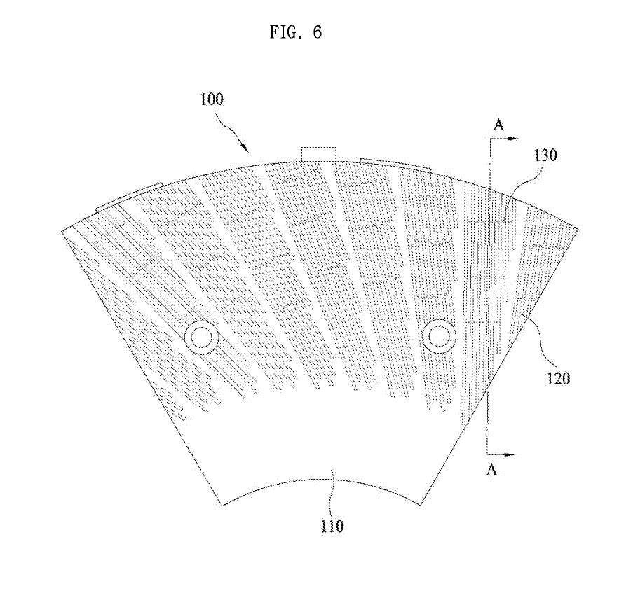

As illustrated in FIG. 6, a refiner bar plate 100 according to the present exemplary embodiment may include a base 110 and fine bars 120.

The base 110 is formed by a method such as casting and may define a body of the refiner bar plate 100. The base 110 may be generally made of a material such as an aluminum alloy which is light in weight and makes it easy to cast the base 100. Of course, the material of the base 110 is not limited thereto and various materials may be applied to the material of the base 110.

The multiple fine bars 120 may be spaced apart from one another and may protrude from the base 110.

In this case, the fine bar 120 may be made of a material different from a material of the base 110. While the base 110 is formed by the casting method, the fine bar 120 is manufactured in advance through a separate process and then integrated with the base 110 when casting the base 110.

That is, the fine bar 120 may be formed by performing rolling and forging on a rolled metal plate or a round bar made of a material of stainless steel 400 and 600 series strong against wear. The fine bar 120 may be manufactured through a cutting processing using a laser or a water jet for the purpose of precision. In this case, a material, which has a higher melting point than the material of the base 110, may be selected as the material of the fine bar 120.

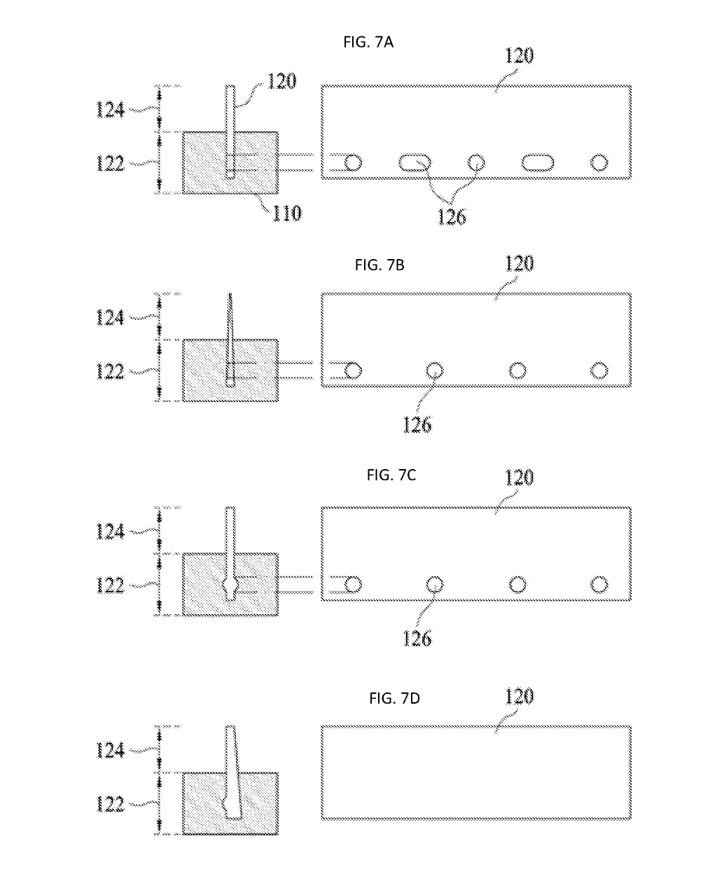

The fine bar 120 may include an embedded portion 122 which is embedded in the base 110, and a protruding portion 124 which protrudes from the base 110. As illustrated in FIGS. 7A to 7D, protrusions 128 or holes 126 may be formed in the embedded portion 122.

Since the protrusions 128 or the holes 126 are formed in the embedded portion 124, molten metal is introduced and hardened in the holes 126 or introduced and hardened at the periphery of the protrusions 128 when casting the base 110, such that a coupling force of the fine bar 120 may be further increased.

In this case, a cross-sectional thickness of the fine bar 120 may be variously set to 0.6 mm to 6.0 mm, and the thickness of the fine bar 120 may be smaller than a thickness of a casting in the related art because the fine bar 120 may be formed by performing the rolling and forging processes on a plate instead of the casting process.

Meanwhile, as illustrated in FIGS. 7A and 7C, the fine bar 120 may have a constant thickness from the embedded portion 122 toward an end of the protruding portion 124. As illustrated in FIG. 7B, the fine bar 120 may have a thickness that decreases from the embedded portion 122 toward the end of the protruding portion 124. Alternatively, as illustrated in FIG. 7D, one side of a cross section of the fine bar 120 may be perpendicular to a surface of the base 110, and the other side of the cross section of the fine bar 120 may be inclined so that a thickness of the fine bar 120 is gradually decreased toward the end of the protruding portion.

Since the other side of the cross section of the fine bar 120 is inclined so that a width of the fine bar 120 is decreased as described above, it is possible to prevent the fine bar 120 from being pulled out by external force after the base 110 is cast.

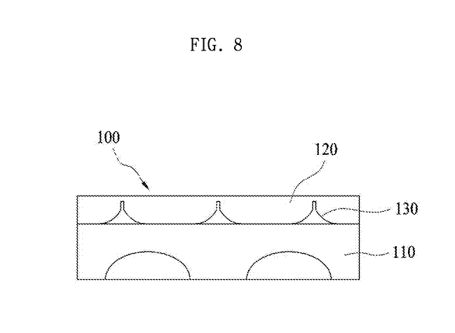

Meanwhile, as illustrated in FIGS. 5 and 8, dams 130 may be formed on the surface of the base 110.

The dam 130 protrudes from the surface of the base 110 between the fine bars 120 and has a height lower than a height of the fine bar 120, such that fibrous materials, which flow through grooves between the fine bars 120, may be guided and flow toward the end of the fine bar 120 once more and then be fibrillated once more.

Hereinafter, a first exemplary embodiment of a method of manufacturing the refiner bar plate according to the first exemplary embodiment of the present invention will be described.

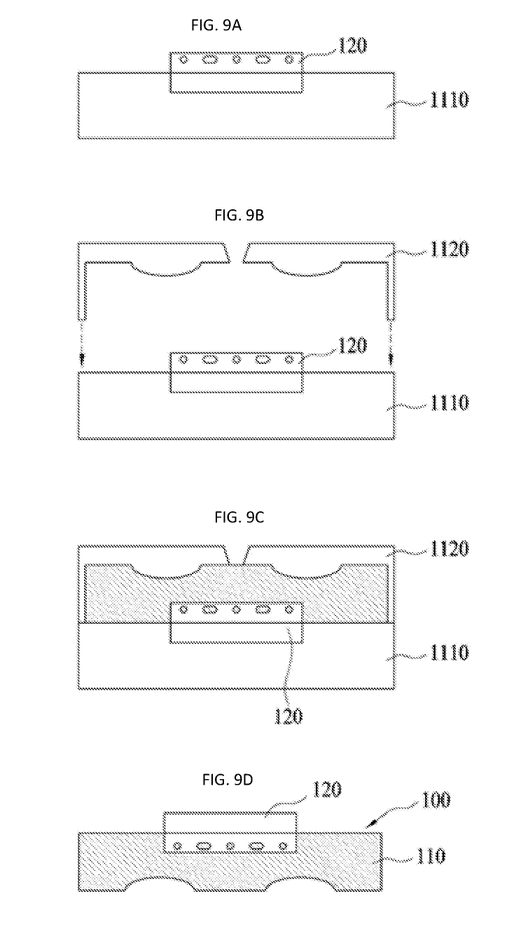

As illustrated in FIG. 9, the method of manufacturing the refiner bar plate according to the present exemplary embodiment may include an insertion step, a mold joining step, a preheating step, and a casting step.

As illustrated in FIG. 9A, the insertion step is a step of inserting the fine bars 120 into a first bar assembling mold 1110 in an inverse manner.

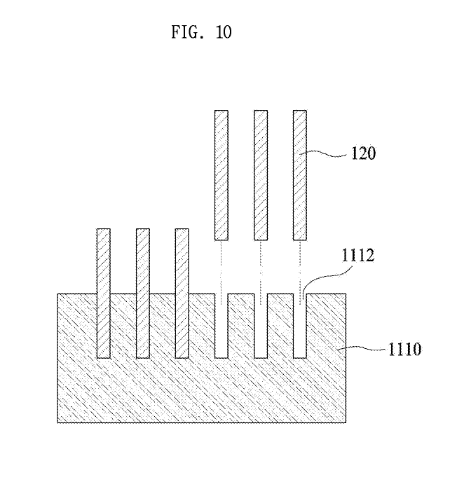

As illustrated in FIG. 10, the first bar assembling mold 1110 has multiple insertion grooves 1112 which are spaced apart from one another and into which the fine bars 120 are inserted in an inverse manner. A surface of the first bar assembling mold 1110 may be provided to define a reverse image of the surface of the base 110 from which the fine bars 120 protrude.

In this case, the insertion of the fine bar 120 in an inverse manner means that the fine bar 120 is inserted such that the protruding portion 124 of the fine bar 120 is embedded in the first bar assembling mold 1110.

As illustrated in FIG. 9B, the mold joining step of joining a first lower mold 1120 to an upper portion of the first bar assembling mold 1110 into which the fine bar 120 is inserted in an inverse manner is performed.

The first lower mold 1120 is a constituent element which is joined to the upper portion of the first bar assembling mold 1110 and defines a space in which the base 110 is formed between the first lower mold 1120 and the first bar assembling mold 1110.

After the mold joining step, the preheating step of preheating the first bar assembling mold 1110 and the first lower mold 1120 may be performed. In the preheating step, the first bar assembling mold 1110 and the first lower mold 1120 may be preheated at 200 to 500° C. In this step, the preheating temperature is not limited to the temperature described in the present exemplary embodiment, and the preheating step may be performed at various temperatures.

Further, as illustrated in FIG. 9C, the casting step is a step of forming the base 110 by injecting ingot steel, which is made of a material different from a material of the fine bar 120, into the internal space between the preheated first bar assembling mold 1110 and the preheated first lower mold 1120.

When the first bar assembling mold 1110 and the first lower mold 1120 are separated after the casting step, the embedded portion 122 of the fine bar 120 is embedded in and integrated with the base 110 as the ingot steel is hardened, such that the refiner bar plate 100 may be manufactured, as illustrated in FIG. 9D.

Hereinafter, a second exemplary embodiment of the method of manufacturing the refiner bar plate according to the first exemplary embodiment of the present invention will be described.

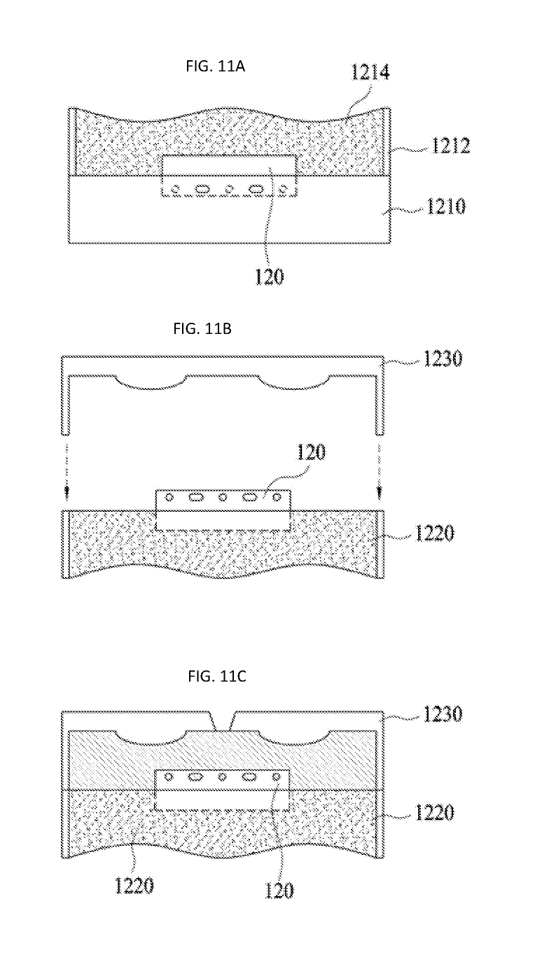

As illustrated in FIG. 11, the method of manufacturing the refiner bar plate according to the present exemplary embodiment may include an insertion step, a first upper shell mold forming step, a mold joining step, and a casting step.

As illustrated in FIG. 11A, the insertion step is a step of inserting the fine bars 120 into a second bar assembling mold 1210 in a normal manner.

The second bar assembling mold 1210 has multiple insertion grooves (not illustrated) into which the fine bars 120 are inserted in a normal manner. A surface of the second bar assembling mold 1210 may be provided to define a shape of a surface of the base 110 from which the fine bars 120 protrude.

In this case, the insertion of the fine bar 120 in a normal manner means that the fine bar 120 is inserted such that the embedded portion 122 of the fine bar 120 is embedded in the insertion groove (not illustrated) of the second bar assembling mold 1210.

The first upper shell mold forming step is a step of manufacturing a first upper shell mold 1220, into which the fine bars 120 are inserted in an inverse manner, by placing a flask 1212 on an upper portion of the second bar assembling mold 1210 into which the fine bars 120 are inserted, filling the flask 1212 with resin coated sand 1214, and heating the resin coated sand 1214.

As illustrated in FIG. 11B, a state in which the first upper shell mold 1220 is manufactured may be a state in which the fine bars 120 are inserted into the first upper shell mold 1220 in an inverse manner.

In the mold joining step, a second lower mold 1230 is joined to an upper portion of the first upper shell mold 1220. As illustrated in FIG. 11C, in the casting step, ingot steel, which is made of a material different from a material of the fine bar 120, may be injected into an internal space between the first upper shell mold 1220 and the second lower mold 1230 to form the base 110.

In this step, the embedded portion 122 of the fine bar 120 is embedded in and integrated with the base 110 as the ingot steel is hardened, such that the refiner bar plate 100 may be manufactured.

Hereinafter, a third exemplary embodiment of the method of manufacturing the refiner bar plate according to the first exemplary embodiment of the present invention will be described.

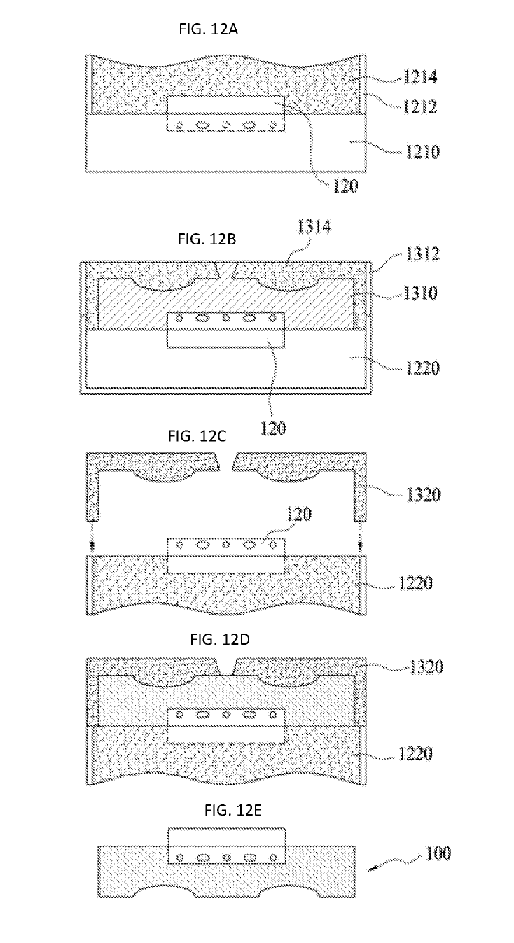

As illustrated in FIG. 12, the method of manufacturing the refiner bar plate according to the present exemplary embodiment may include an insertion step, a first upper shell mold forming step, a first lower shell mold forming step, a mold joining step, and a casting step.

As illustrated in FIG. 12A, the insertion step is a step of inserting the fine bars 120 into a second bar assembling mold 1210 in a normal manner, and the first upper shell mold forming step is a step of forming a first upper shell mold 1220 by using a flask 1212, resin coated sand 1214, and the second bar assembling mold 1210 into which the fine bars 120 are inserted. Because the insertion step and the first upper shell mold forming step are substantially identical to the insertion step and the first upper shell mold forming step according to the second exemplary embodiment of the method of manufacturing the refiner bar plate, a detailed description thereof will be omitted.

As illustrated in FIG. 12B, the first lower shell mold forming step may form a first lower shell mold 1320 by positioning a flask 1312 and a lower core 1310 on an upper portion of the first upper shell mold 1220 formed in the first upper shell mold forming step, filling the flask 1312 with resin coated sand 1314, and heating the resin coated sand 1314.

In this case, the lower core 1310 may have a shape of the base 110 to be formed.

Further, as illustrated in FIG. 12C, in the mold joining step, the first upper shell mold 1220 and the first lower shell mold 1320 are joined. As illustrated in FIG. 12D, in the casting step, ingot steel, which is made of a material different from a material of the fine bar 120, is injected into the first upper shell mold 1220 and the first lower shell mold 1320 which are joined together, such that the base 110 is formed. As a result, it is possible to manufacture the refiner bar plate 100, in which the base 110 and the fine bar 120 are integrated, as illustrated in FIG. 12E.

Hereinafter, a fourth exemplary embodiment of the method of manufacturing the refiner bar plate according to the first exemplary embodiment of the present invention will be described.

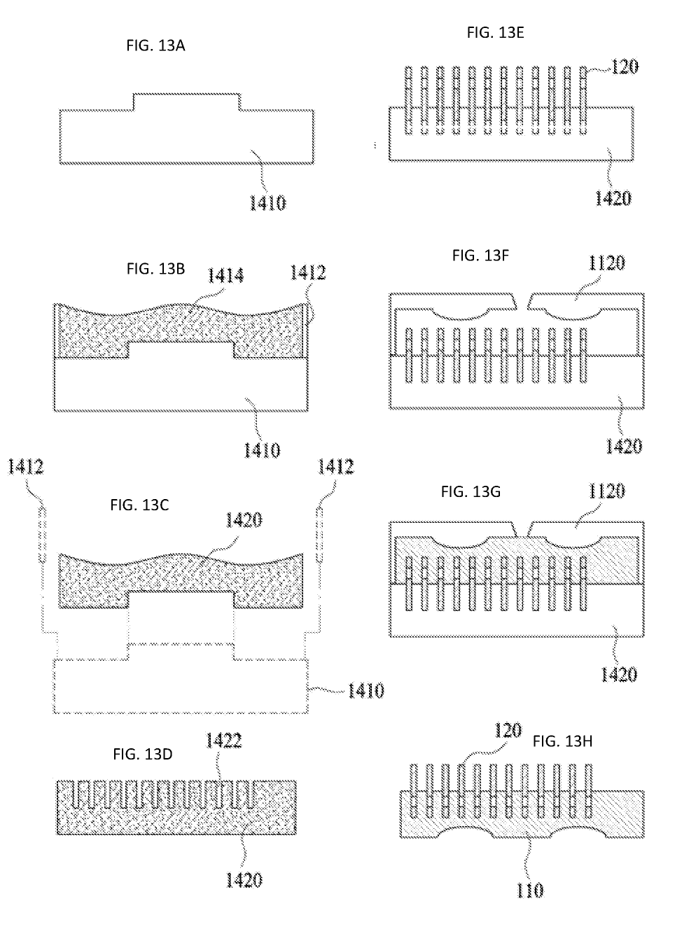

As illustrated in FIG. 13, the method of manufacturing the refiner bar plate according to the present exemplary embodiment may include a second upper shell mold forming step, a fine bar insertion step, a mold joining step, and a casting step.

As illustrated in FIG. 13A, the second upper shell mold forming step is a step of forming a second upper shell mold 1420, which has insertion grooves 1422 into which the fine bars 120 are inserted, by placing a flask 1412 on an upper core 1410 having a shape of a silhouette in a state in which the fine bars are inserted in a normal manner, as illustrated in FIG. 13B, filling the flask 1412 with resin coated sand 1414, and then heating the resin coated sand 1414.

As illustrated in FIG. 13A, the upper mold 1410 may be made of a material such as metal, heat-resistant plastic, or wood and manufactured to have a shape of a silhouette in a state in which the multiple fine bars are inserted in a normal manner.

Therefore, as illustrated in FIGS. 13C and 13D, the second upper shell mold 1420 may have the insertion grooves 1422 which are formed in multiple rows to correspond to the protruding portions of the fine bars 120.

As illustrated in FIG. 13E, the fine bar insertion step is a step of inserting the fine bars 120 in an inverse manner into the insertion grooves 1422 of the manufactured second upper shell mold 1420.

As illustrated in FIG. 13F, the mold joining step is a step of joining a first lower mold 1120 to an upper portion of the second upper shell mold 1420 into which the fine bars 120 are inserted. In the mold joining step, the first lower mold 1120 and the second upper shell mold 1420 are joined together, such that a space in which the base 110 is formed may be formed between the first lower mold 1120 and the second upper shell mold 1420.

As illustrated in FIG. 13G, in the casting step, ingot steel, which is made of a material different from a material of the fine bar 120, is injected between the second upper shell mold 1420 and the first lower mold 1120 which are joined together, such that the base 110 is formed. As a result, as illustrated in FIG. 13H, it is possible to manufacture the refiner bar plate 100 in which the base 110 and the fine bar 120 are integrated.

Hereinafter, a second exemplary embodiment of the refiner bar plate according to the present invention will be described.

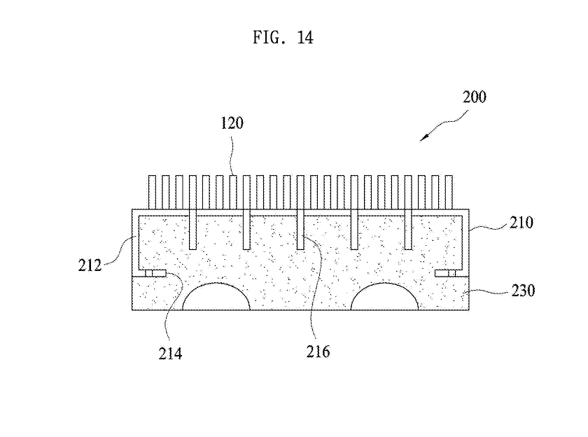

As illustrated in FIG. 14, the refiner bar plate according to the present exemplary embodiment may include a fine bar plate 210 and a base 230.

The fine bar plate 210 may have multiple fine bars 120 which are coupled, by welding, to one surface that defines a bottom surface of the base 230 of the refiner bar plate 100.

In this case, the fine bar plate 210 may be formed by coupling the multiple fine bars 120 to a flat metal plate in a normal manner by welding. In this case, a material of the metal plate may be identical to or different from a material of the fine bar 120.

In this case, because the fine bar 120 is substantially identical to the fine bar of the refiner bar plate according to the first exemplary embodiment, a detailed description thereof will be omitted.

Further, the base 230 is formed by casting at a lower side of the fine bar plate 210, the base 230 is made of a material which is different from a material of the fine bar 120 and makes it easy to perform casting, and the base 230 may be integrated with the fine bar plate 210.

Meanwhile, the fine bar plate 210 may have skirts 212, flanges 214, and ribs 216 to increase coupling force between the fine bar plate 210 and the base 230.

The skirt 212 may be formed by bending both rims of the fine bar plate 210 downward, and the flange 214 may be formed by bending an end of the skirt 212 inward so that the end of the skirt 212 is directed toward a center of the base 230.

In addition, the multiple ribs 216 may protrude from a surface of the fine bar plate 210 which is opposite to the surface from which the fine bars 120 protrude.

Therefore, the skirts 212, the flanges 214, and the ribs 216 are integrated when the ingot steel of the base 230 formed by casting is hardened, such that the coupling force may be increased.

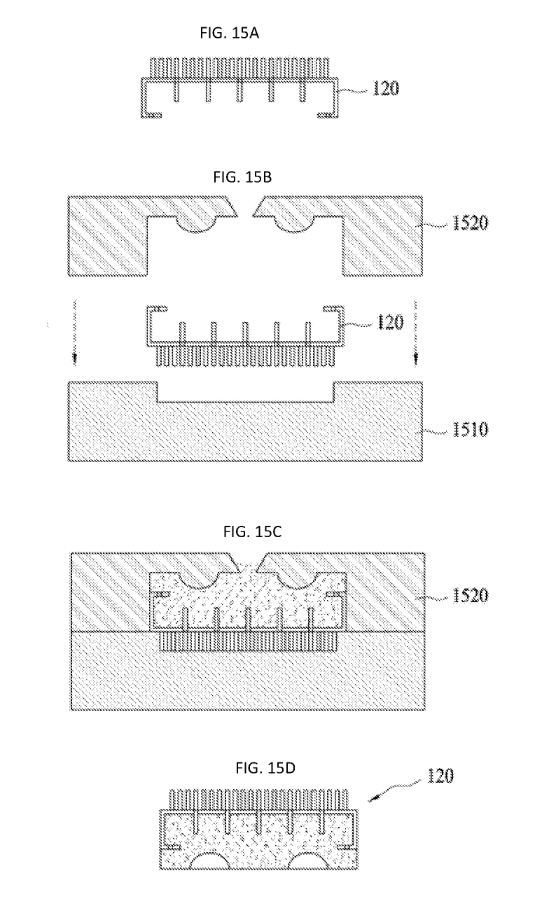

Hereinafter, a fifth exemplary embodiment of the method of manufacturing the refiner bar plate according to the second exemplary embodiment of the present invention will be described with reference to FIG. 15.

The method of manufacturing the refiner bar plate according to the present exemplary embodiment may include a fine bar plate manufacturing step, a mold joining step, and a casting step.

As illustrated in FIG. 15A, the fine bar plate manufacturing step is a step of manufacturing a fine bar plate 210 by coupling, by a method such as welding, the multiple fine bars 120 to one surface of a plate which is formed to define a bottom surface of the base 230 of the refiner bar plate 200.

In the fine bar plate manufacturing step, the skirt 212 and the flange 214 may be formed by bending a rim of the plate.

In addition, in the fine bar plate manufacturing step, the ribs 216 may be formed, by welding, on a surface opposite to the surface to which the fine bars 120 are coupled by welding.

As illustrated in FIG. 15B, in the mold joining step, the fine bar plate 210 manufactured in the fine bar plate manufacturing step is reversed and positioned in an inverse manner between an upper mold 1510 and a first lower mold 1520, and then the upper mold 1510 and the first lower mold 1520 may be joined together.

Further, as illustrated in FIG. 15C, in the casting step, ingot steel, which is made of a material different from a material of the fine bar 120, is injected into an internal space between the upper mold 1510 and the first lower mold 1520 and then cooled and hardened.

In the casting step, the skirts 212, the flanges 214, and the ribs 216 are integrated when the ingot steel on the base 230 is hardened, such that the coupling force may be further increased.

Hereinafter, a third exemplary embodiment of the refiner bar plate according to the present invention will be described.

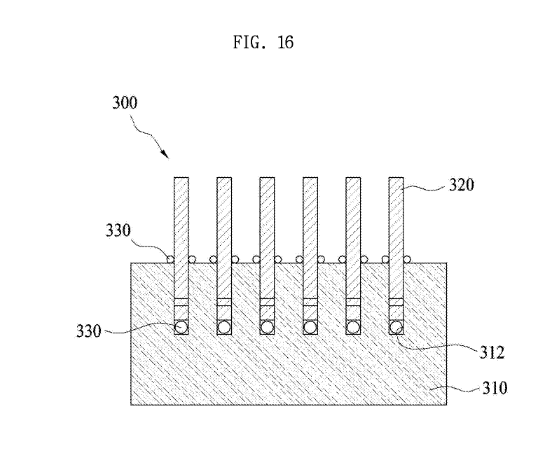

As illustrated in FIG. 16, a refiner bar plate 300 according to the present exemplary embodiment may include a base 310, fine bars 320, and fillers 330.

Multiple insertion grooves 312 may be formed in one surface of the base 310, the base 310 may be formed by a method such as casting, and the insertion grooves 312 may be formed by machining.

Like the fine bars 120 according to the above-mentioned exemplary embodiments, the fine bar 320 is made of a material different from a material of the base 310 and may be inserted into the insertion grooves 312 so as to protrude from the base 310.

Further, the fillers 330, together with the fine bars 320, are inserted into the insertion grooves 312. The fillers 330 are melted by brazing, and then cooled and hardened, thereby coupling the fine bars 320 into the insertion grooves 312 by brazing welding.

Hereinafter, a sixth exemplary embodiment of the method of manufacturing the refiner bar plate 300 according to the third exemplary embodiment of the present invention will be described.

The method of manufacturing the refiner bar plate according to the present exemplary embodiment may include a filler insertion step, a fine bar insertion step, and a heating step.

The filler insertion step is a step of inserting the fillers 330 into the insertion grooves 312 of the base 310. In this case, a material, which has a lower melting point than the base 310 and the fine bar 320, may be selected as a material of the filler 330.

In this case, the insertion grooves 312 may be formed in the surface of the base 310, and the base 310 may be formed by a method such as casting.

Further, the fine bar insertion step is a step of inserting the fine bars 320 into the insertion grooves 312 of the base 310 in the state in which the fillers 330 are inserted into the insertion grooves 312. Like the fine bar according to the above-mentioned exemplary embodiments, the fine bar 320 may be made of a material which has excellent wear resistance and mechanical strength and is different from a material of the base 310, and the fine bar 320 may be manufactured by plastic processing such as forging or pressing instead of casting.

Therefore, the filler 330 and the fine bar 320 are inserted together into the insertion grooves 312 of the base 310.

In addition, in the heating step, the base 310, into which the fillers 330 and the fine bars 320 are inserted, is heated to melt the fillers 330, thereby implementing brazing welding.

Therefore, as the fillers are cooled after the heating step, the fine bars 320 may be coupled to the base 310 by brazing welding.

While the exemplary embodiments according to the present invention have been described above, it is obvious to those skilled in the art that the present invention may be specified in other particular forms in addition to the aforementioned exemplary embodiments without departing from the spirit or the scope of the present invention. Accordingly, it should be understood that the aforementioned exemplary embodiments are not restrictive but illustrative, and thus the present invention is not limited to the aforementioned description, and may be modified within the scope of the appended claims and the equivalent range thereto.

### Industrial Applicability

The present invention may implement improved productivity and lightweight required for the refining process and may also reduce production costs and management costs, and as a result, the present invention may be applied to and used in a field related to the refining process.

1. A refiner bar plate comprising:
a base which defines a body; and
multiple fine bars which are spaced apart from one another, protrude from the base, and are made of a material different from a material of the base.

2. The refiner bar plate of claim 1, wherein the fine bar includes an embedded portion which is embedded in the base, and a protruding portion which protrudes from the base.

3. The refiner bar plate of claim 2, wherein at least one hole is formed in the embedded portion of the fine bar.

4. The refiner bar plate of claim 2, wherein at least one protrusion is formed on the embedded portion of the fine bar.

5. The refiner bar plate of claim 2, wherein the fine bar has a constant thickness from the embedded portion to the protruding portion.

6. The refiner bar plate of claim 2, wherein the fine bar gradually decreases in thickness from the embedded portion toward the protruding portion.

7. The refiner bar plate of claim 2, wherein one side of a cross section of the fine bar is perpendicular to the base, and the other side of the cross section of the fine bar is inclined such that a thickness of the fine bar is decreased toward an end of the protruding portion.

8. The refiner bar plate of claim 1, wherein a dam is further formed to protrude from the base between the fine bars.

9. A method of manufacturing a refiner bar plate, the method comprising:
an insertion step of inserting fine bars, in an inverse manner, into a first bar assembling jig having multiple insertion grooves which are spaced apart from one another and into which the fine bars are inserted in an inverse manner;
a mold joining step of positioning and joining a first lower mold, which is joined to an upper portion of the first bar assembling jig to define a space between the first lower mold and the first bar assembling jig in which a base is formed, to the upper portion of the first bar assembling jig into which the fine bars are inserted;
a preheating step of preheating the first bar assembling jig and the first lower mold which are joined together; and
a casting step of forming the base by injecting ingot steel, which is made of a material different from a material of the fine bar, into the internal space between the preheated first bar assembling jig and the preheated first lower mold.

10. A method of manufacturing a refiner bar plate, the method comprising:
an insertion step of inserting fine bars, in a normal manner, into a second bar assembling jig having multiple insertion grooves which are spaced apart from one another at predetermined intervals and into which the fine bars are inserted in a normal manner;
a first upper shell mold forming step of manufacturing a first upper shell mold, into which the fine bars are inserted in an inverse manner, by placing a flask on an upper portion of the second bar assembling jig into which the fine bars are inserted, filling the flask with resin coated sand, and heating the resin coated sand;
a mold joining step of positioning and joining a second lower mold, which is joined to an upper portion of the second bar assembling jig to allow a base to be formed between the second lower mold and the second bar assembling jig, to an upper portion of the first upper shell mold; and
a casting step of forming the base by injecting ingot steel, which is made of a material different from a material of the fine bar, into an internal space between the first upper shell mold and the second lower mold.

11-17. (canceled)
